(19) United States
(12) Patent Application Publication
(10) Pub. No.: US 2014/0166527 A1
(43) Pub. Date: Jun. 19, 2014

(54) Inhalation Anesthetic Product

(71) Applicants: Ling Ye, Beijing (CN); Clive P. Bosnyak, Dripping Springs, TX (US)

(72) Inventors: Ling Ye, Beijing (CN); Clive P. Bosnyak, Dripping Springs, TX (US)

(73) Assignee: Hospira, Inc., Lake Forest, IL (US)

(21) Appl. No.: 14/001,069

(22) PCT Filed: Feb. 23, 2012
(86) PCT No.: PCT/US12/26331

§ 371 Date: Mar. 3, 2014

Related U.S. Application Data
(60) Provisional application No. 61/445,795, filed on Feb. 23, 2011.

(51) Int. Cl. A61J 1/00; B65B 3/00

(52) U.S. Cl. CPC A61J 1/00; B65B 3/003
USPC 206/524.6; 53/473

(57) ABSTRACT

A pharmaceutical product including a container constructed from a polymeric material containing one or more of a terephthalate ester group, an amorphous nylon, fluorinated ethylene-propylene, and combinations thereof. The container defines an interior space. A volume of a fluoroether-containing inhalation anesthetic is contained in the interior space defined by the container.

### CROSS REFERENCE TO RELATED APPLICATION

This application claims benefit of U.S. Provisional Application No. 61/445,795, filed Feb. 23, 2011, which is incorporated herein by reference in its entirety.

### FIELD OF THE INVENTION

The invention relates to a container for an inhalation anesthetic and a method for storing an inhalation anesthetic. More particularly, the invention relates to a container constructed from a material that provides a resistance to vapor transmission through a wall of the container and that is non-reactive with an inhalation anesthetic contained therein.

### DESCRIPTION OF RELATED ART

Glass containers are typically used to house fluoroether inhalation anesthetic agents such as sevoflurane (fluoromethyl-2,2,2-trifluoro-1-(trifluoromethyl)ethyl ether), enflurane (2-chloro-1,1,2-trifluoroethyl difluoromethyl ether), isoflurane (1-chloro-2,2,2-trifluoroethyl difluoromethyl ether), methoxyflurane (2,2-dichloro-1,1-difluoroethyl methyl ether) and desflurane (2-difluoromethyl 1,2,2,2-tetrafluoroethyl ether). These anesthetic agents are used as inhaling agents for induction and maintenance of general anesthesia. Although glass is generally chemically and physically inert, glass under certain conditions is both chemically and physically reactive. It has been found that under certain conditions the fluoroether agent and the glass container may interact, thereby facilitating degradation of the fluoroether agent. This interaction is believed to result from the presence of Lewis acids in the glass container material. Lewis acids have an empty orbital which can accept an unshared pair of electrons and thereby provide a potential site for reaction with the alpha fluoroether moiety (—C—O—C—F) of the fluoroether agent. Degradation of these fluoroether agents in the presence of a Lewis acid may result in the production of degradation products such as hydrofluoric acid.

A glass material that has been used to contain these fluoroether agents is referred to as Type III glass. This material contains silicon dioxide, calcium hydroxide, sodium hydroxide and aluminum oxide. Type III glass provides a barrier to the transmission of vapor through the wall of the container, thereby preventing the transmission of the fluoroether agent therethrough and preventing the transmission of other vapors into the container. However, the aluminum oxides contained in glass materials such as type III glass tend to act as Lewis acids when exposed directly to the fluoroether agent, thereby facilitating degradation of the fluoroether agent. The degradation products produced by this degradation, e.g., hydrofluoric acid, may etch the interior surface of the glass container, thereby exposing additional quantities of aluminum oxide to the fluoroether compound and thereby facilitating further degradation of the fluoroether compound. In some cases, the resulting degradation products may compromise the structural integrity of the glass container.

Efforts have been made to inhibit the reactivity of glass to various chemicals. For example, it has been found that treating glass with sulfur will protect the glass material in some cases. However, it will be appreciated that the presence of sulfur on the surface of a glass container is not acceptable in many applications.

Furthermore, glass containers present a breakage concern. For example, glass containers may break when dropped or are otherwise subjected to a sufficient force, either in use or during shipping and handling. Such breakage can cause medical and incidental personnel to be exposed to the contents of the glass container. In this regard, inhalation anesthetic agents evaporate quickly. Thus, if the glass container contains an inhalation anesthetic such as sevoflurane, breakage of the container may necessitate evacuation of the area immediately surrounding the broken container, e.g., an operating room or medical suite.

Efforts to address breakage concerns typically have involved coating the exterior, non-product contact surfaces of the glass with polyvinyl chloride (PVC) or synthetic resin such as SURLYN® (a registered trademark of E. I. Du Pont De Nemours and Company). These efforts increase the cost of the containers, are not aesthetically pleasing, and do not overcome the above-discussed problems related to degradation which can occur when using glass to contain fluoroether-containing inhalation anesthetic agents.

In an effort to use a material other than glass, aluminum has been used for the container. Aluminum bottles must have an internal lacquer liner, typically made of an epoxyphenolic resin, to prevent the inhalation anesthetic from being contaminated with aluminum particles. This involves another step in the manufacturing process and is more costly. Additionally, the inhalation anesthetic cannot be visually inspected for particulates or cloudiness when an aluminum container is used.

Polyethylene napthalate (“PEN”) has been used as a container for sevoflurane. PEN is lightweight and has a see-through capability. However, PEN is not a large volume commodity plastic and is costly to use as a material. Other thermoplastics such as polyethylene, polypropylene, ionomers and 4-methylpentene have been suggested as a material for a container, but these are not clear materials and present the same problem as aluminum containers in that they do not allow the inhalation anesthetic to be visually inspected through the container. In addition, these thermoplastics can be too soft and thus more flexible than desired. Other thermoplastic materials may present additional drawbacks for use, such as lack of permeation resistance to sevoflurane, stress-cracking in the presence of sevoflurane, and residual monomer migration.

Accordingly, the inventors have identified a need in the art to provide a thermoplastic container for sevoflurane and other inhalation anesthetics that provides superior resistance to vapor transmission, inertness, clarity, and toughness for the long term storage, handling and delivery of the inhalation anesthetics.

### SUMMARY OF THE INVENTION

One aspect of the invention involves a container constructed from a material containing a polyester with one or more of a terephthalate ester group, an amorphous nylon, fluorinated ethylene-propylene, and combinations thereof. The container defines an interior space constructed to contain an inhalation anesthetic. Inside the container is a volume of a fluoroether agent.

In various aspects of the invention, the material comprises a compound selected from the group consisting of polyethylene terephthalate and polyethylene terephthalate glycol co-polyester.

In other aspects, the fluoroether agent is selected from the group consisting of sevoflurane, desflurane, isoflurane, enflurane, and methoxyflurane.

A further aspect of the invention is directed to a method for storing an inhalation anesthetic external to a patient's body. The method includes providing a container defining an interior space, wherein the container is constructed from a material comprising a compound selected from the group consisting of a polyester containing a terephthalate ester group, an amorphous nylon, fluorinated ethylene-propylene, and combinations thereof. A volume of a fluoroether agent is placed in the interior space defined by the container.

Still further, in various embodiments of the invention, the container defines an opening therein, the opening providing fluid communication between the interior space defined by the container and an external environment of the container, wherein the invention includes a cap constructed to seal the opening. The cap may be constructed from materials such as polyethylene, polyethylene napthalate, polymethylpentene, ionomeric resins, polyesters containing a terephthalate ester group, an amorphous nylon, fluorinated ethylene-propylene, and combinations thereof.

The interior surface of the cap may be constructed from a material such as a polyester containing a terephthalate ester group, an amorphous nylon, fluorinated ethylene-propylene, polyvinyl alcohol, and combinations thereof.

### BRIEF DESCRIPTION OF THE DRAWINGS

FIG. 1 is cross-sectional view of a pharmaceutical product constructed in accordance with the present invention.

FIG. 2 is a chart demonstrating the weight loss of sevoflurane in a PEN container over time.

FIG. 3 is a chart demonstrating the weight loss of sevoflurane in a PET container over time.

FIG. 4 is a chart demonstrating the weight loss of sevoflurane in a PETG container over time.

FIG. 5 is a chart demonstrating the weight loss of sevoflurane in an amorphous nylon container over time.

### DETAILED DESCRIPTION

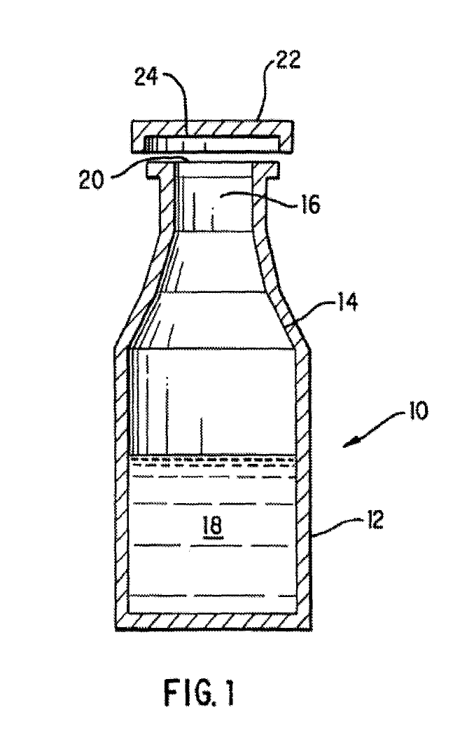

An inhalation anesthetic product constructed in accordance with the present invention is generally indicated at 10 of FIG. 1. Inhalation anesthetic product 10 includes a container 12 having an interior surface 14. Interior surface 14 defines an interior space 16 within container 12. An inhalation anesthetic 18 is contained within interior space 16 of container 12. In an embodiment of the present invention, inhalation anesthetic 18 contains a fluoroether compound. Fluoroether-containing inhalation anesthetics useful in connection with the present invention include, but are not necessarily limited to, sevoflurane, enflurane, isoflurane, methoxyflurane, and desflurane. In various embodiments, the inhalation anesthetic 18 is a fluid, and may include a liquid phase, a vapor phases, or both liquid and vapor phases. FIG. 1 depicts inhalation anesthetic 18 in a liquid phase.

The purpose of container 12 is to contain inhalation anesthetic 18. In the embodiment of the present invention depicted in FIG. 1, container 12 is in the shape of a bottle. However, it will be appreciated that container 12 can have a variety of configurations and volumes without departing from the spirit and scope of the present invention. For example, container 12 can be configured as a shipping vessel for large volumes (e.g., tens or hundreds of liters) of inhalation anesthetic 18. Such shipping vessels can be rectangular, spherical, or oblong in cross-section without departing from the intended scope of the invention. Alternatively, the container volume could be less than 100 cm³ for rapid and convenient deployment in emergency situations.

As depicted in FIG. 1, container 12 defines an opening 20. Opening 20 facilitates the filling of container 12 and provides access to the contents of container 12, thereby allowing the contents to be removed from container 12 when they are needed. In the embodiment of the present invention depicted in FIG. 1, opening 20 is a mouth of a bottle or vial. However, it will be appreciated that opening 20 can have a variety of known configurations without departing from the scope of the present invention.

In various aspects of the invention, container 12 is constructed of a material that minimizes the amount of vapor transmission into and out of container 12, thereby minimizing the amount of inhalation anesthetic 18 that is released from interior space 16 of container 12 and thereby minimizing the amount of vapor transmission, e.g., water vapor transmission, from an external environment of container 12 into interior space 16 and thus into inhalation anesthetic 18. Container 12 also is preferably constructed of a material that does not facilitate degradation of inhalation anesthetic 18. In addition, container 12 preferably is constructed of a material that minimizes the potential for breakage of container 12 during storage, shipping, and use.

In a particular example, a container that contains polyethylene terephthalate provides the desired vapor barrier, chemical inertness, and strength characteristics when used with inhalation anesthetics 18. In addition, polyethylene terephthalate is naturally colorless and has high transparency. Polyethylene terephthalate is a thermoplastic polymer resin of the polyester family.

One of ordinary skill will appreciate that there are many different types of polyethylene terephthalate polymers which vary in their molecular weight, additives, and terephthalate content. These include, for example, poly(ethylene terephthalate) (PET), poly(trimethylene terephthalate) (PTT), poly(butylene terephthalate) (PBT), poly(pentamethylene terephthalate), poly(hexamethylene terephthalate), poly(cyclohexylene terephthalate), poly(1,4-cyclohexanedimethylene terephthalate) (Kodel), and poly(1,3-cyclopentanedimethylene terephthalate).

Amorphous nylon polymers are also useful as a material for the container. A family of amorphous nylons, manufactured by EMS-GRIVORY, is available under the GRILAMID® tradename: for example. GRILAMID® TR45, TR55, and TR90. These products are transparent polyamides based on aliphatic, cyclo-aliphatic units.

Polymers useful in the invention can be categorized into three distinct groups; namely, homopolymers, copolymers and blends. It has been found that polyethylene terephthalate homopolymers can provide higher barriers to vapor transmission when compared to polyester copolymers and blends. For this reason, in one embodiment, the material from which container 12 of the present invention is constructed contains a polyethylene terephthalate homopolymer. However, it will be appreciated that certain copolymers and blends of polyethylene terephthalate can be used in connection with the present invention, provided they provide an adequate resistance to the transmission of vapors, e.g., inhalation anesthetic, therethrough, and provided that they provide the desired strength and non-reactivity to inhalation anesthetic 18. In addition to the desirable vapor barrier characteristics of materials containing polyethylene terephthalate, polyethylene terephthalate does not contain Lewis acids and therefore does not pose any threat of facilitating the degradation of a fluoroether-containing inhalation anesthetic contained in a container constructed therefrom.

Polyethylene terephthalate differs structurally from polyethylene napthalate in that polyethylene napthalate contains a fused double aromatic ring instead of the single benzene ring of the terephthalate. The additional stiffness imposed by the fused double aromatic ring results in a higher glass transition temperature (Tg) of over 100° C. for polyethylene napthalate versus about 75° C. for polyethylene terephthalate. The glass transition temperature is defined as that temperature below which the polymer is rigid and above which it is rubbery in nature. Decreasing the temperature below the glass transition temperature results in polymers being more brittle. This change in monomer from napthalate to terephthalate results in polyethylene terephthalate having superior impact performance than PEN. Incorporation of amounts of isopthalate units in the polyester leads to further reductions of glass transition so that at 50/50 molar ratio isophthalate:terephthalate groups the Tg is about 50° C. This reduced glass transition temperature for the iso/terephthalate copolymer results in further improvements in impact resistance. See Modern Polyesters. Chemistry and Technology of Polyesters and Copolyesters. Eds. John Scheirs and Timothy E. Long, Wiley Series in Polymer Science, Wiley, 2003.

In one embodiment of the present invention, container 12 is constructed of a single layer of material. That is, container 12 is substantially homogenous throughout its thickness. In this embodiment, as above-discussed, container 12 is constructed of a material that contains polyethylene terephthalate. In various aspects, the material may have a thickness of more than about 80 μm, more than about 90 μm, more than about 100 μm, more than about 120 μm, and more than about 150 μm. Containers constructed of such materials provide a sufficient barrier to transmission of inhalation anesthetic through the material. In various embodiments, permeation of the inhalation anesthetic through the material is less than about 1.0%, less than about 1.5%, less than about 2.0%, and less than about 2.5% by weight per one year at room temperature storage. Room temperature is generally about 60° F. to about 80° F. In a particular embodiment, the material has a thickness of about 600 μm and permeation of the anesthetic through the material is less than about 2.0% per year at room temperature.

In an alternative embodiment of the present invention, container 12 is multi-laminar. As used herein, the term multi-laminar is intended to include (i) materials constructed of more than one lamina where at least two of the lamina are constructed of different materials, i.e., materials that are chemically or structurally different, or materials that have different performance characteristics, wherein the lamina are bonded to one another or otherwise aligned with one another so as to form a single sheet; (ii) materials having a coating of a different material; (iii) materials having a liner associated therewith, the liner being constructed of a different material; and (iv) known variations of any of the above. In this alternative embodiment of the present invention, interior surface 14 of container 12 is preferably constructed of a material containing polyethylene terephthalate. It will be appreciated that the surface of container 12 in contact with a fluoroether-containing inhalation anesthetic contained therein will preferably contain polyethylene terephthalate in order to provide the desired vapor transmission resistance characteristics and simultaneously minimize the likelihood of degradation of the fluoroether-containing inhalation anesthetic.

One of ordinary skill in the art will appreciate that a coating can be applied to an interior surface of container 12 using a variety of known techniques. The technique will vary dependent upon (i) the material from which container 12 is made; and (ii) the coating material being applied to container 12. For example, a coating can be applied to the interior surface of container 12 by heating container 12 to at least the melting point of the coating material being applied thereto. The coating material is then applied to the heated container 12 using a variety of known techniques, e.g., by spraying an atomized coating material onto the interior surface. The container 12 is then allowed to cool to a temperature below the melting point of the coating material, thereby causing the coating material to form a single, unbroken film or layer, i.e., interior surface 14. Useful materials for use as coatings are polyvinyl acetate or polyvinyl alcohol.

In an alternative embodiment, container 12 may be coextruded or blended with polyvinyl acetate or polyvinyl alcohol for improved gas-resistance and the ability to withstand impact and prevent breakage. These materials can be conveniently blended using a melt extruder or coextruded using a multilayer die geometry common to the packaging industry. The blends or coextruded systems can be blow molded or extrusion blow molded into a large variety of containers.

Methods for making containers of the type used in the present invention are known in the art. For example, it is known that polyethylene terephthalate should be dried to a moisture level of approximately 0.005% prior to processing in order to yield the optimal physical properties in container 12 and cap 22. An exemplary method for making containers 12 and caps 22 useful in connection with the present invention entails the injection-stretch-blow molding of a material containing polyethylene terephthalate. The polyethylene terephthalate-containing material is injection molded into a preform which is then transferred to a blow station where it is stretched and blown to form the container. The container can be further batch heated and annealed in a convective oven to improve vapor transmission resistance if desired.

Cap 22 is constructed to fluidly seal opening 20, thereby fluidly sealing inhalation anesthetic 18 within container 12. Cap 22 can be constructed from a variety of known materials. However, it is preferable that cap 22 be constructed of a material that minimizes the transmission of vapor therethrough and that minimizes the likelihood of degradation of inhalation anesthetic 18. In an embodiment of the present invention, cap 22 is constructed from a material containing polyethylene terephthalate. In an alternative embodiment of the present invention, cap 22 has an interior surface 24 that is constructed from a material containing polyethylene terephthalate. In another alternative embodiment of the present invention, cap 22, and/or interior surface 24 thereof, is constructed from one of the materials that is suitable for the container including, for example, a polyester containing a terephthalate ester group, an amorphous nylon, or fluorinated ethylene-propylene, the material having vapor barrier characteristics sufficient to minimize the transmission of water vapor and inhalation anesthetic vapor therethrough. In still another alternative embodiment of the present invention, cap 22, and/or interior surface 24 thereof, is constructed of a material containing polyethylene terephthalate glycol co-polyester.

Accordingly, it is to be appreciated that cap 22, and/or interior surface 24 thereof, can be constructed from one of the same materials that is suitable for the container including, for example, a polyester containing a terephthalate ester group, an amorphous nylon, a fluorinated ethylene-propylene, polyethylene terephthalate, polyethylene terephthalate glycol co-polyester, and combinations thereof. As above-discussed with respect to container 12, cap 22 can be homogenous, or may be multi-laminar in nature. Cap 22 and container 12 can be constructed such that cap 22 can be threadingly secured thereto. Containers and caps of this type are well known. Alternative embodiments of cap 22 and container 12 are also possible and will be immediately recognized by those of ordinary skill in the relevant art. Such alternative embodiments include, but are not necessarily limited to, caps that can be “snap-fit” on containers, caps that can be adhesively secured to containers, and caps that can be secured to containers using known mechanical devices, e.g., a ferrule. In an embodiment of the present invention, cap 22 and container 12 are configured such that cap 22 can be removed from container 12 without causing permanent damage to either cap 22 or container 12, thereby allowing a user to reseal opening 20 with cap 22 after the desired volume of inhalation anesthetic 18 has been removed form container 12.

The method of the present invention includes the step of providing a predetermined volume of a fluoroether-containing inhalation anesthetic 18. The fluoroether-containing inhalation anesthetic 18 can be one or more of sevoflurane, enflurane, isoflurane, methoxyflurane, and desflurane. A container 12 constructed in accordance with the above-described pharmaceutical product also is provided. In particular, container 12 defines an interior space 16 and is constructed of a material containing polyethylene terephthalate, wherein the polyethylene terephthalate is present on interior surface 14 of container 12, either as a result of the homogenous material characteristics of container 12, or as a result of interior surface 14 of a multi-laminar material being constructed of polyethylene terephthalate, as above-discussed. The method of the present invention further includes the step of placing the predetermined volume of fluoroether-containing inhalation anesthetic 18 into the interior space defined by the container.

In an alternative embodiment of the method of the present invention, a predetermined volume of a fluoroether-containing inhalation anesthetic 18 is provided. The fluoroether-containing inhalation anesthetic 18 can be one or more of sevoflurane, enflurane, isoflurane, methoxyflurane, and desflurane. A container 12 constructed in accordance with the above described product also is provided. In particular, container 12 defines an interior space 16 and is constructed of a material containing one or more of a terephthalate ester group, an amorphous nylon, fluorinated ethylene-propylene, or any combinations thereof, wherein the recited material(s) is present on interior surface 14 of container 12 either as a result of the homogenous material characteristic of container 12, or as a result of interior surface 14 of a multi-laminar material being constructed of one of the referenced materials, as above-discussed. The method further includes the step of placing the predetermined volume of a fluoroether-containing inhalation anesthetic 18 into the interior space defined by the container.

It will be appreciated that container 12, and interior surface 14 thereof, can be constructed of more than one of the above-referenced materials.

The following examples are provided for exemplification purposes only and are not intended to limit the scope of the invention described in broad terms above.

### EXAMPLES

### Example 1

### Determination of Permeation of Sevoflurane Through Plastic Containers

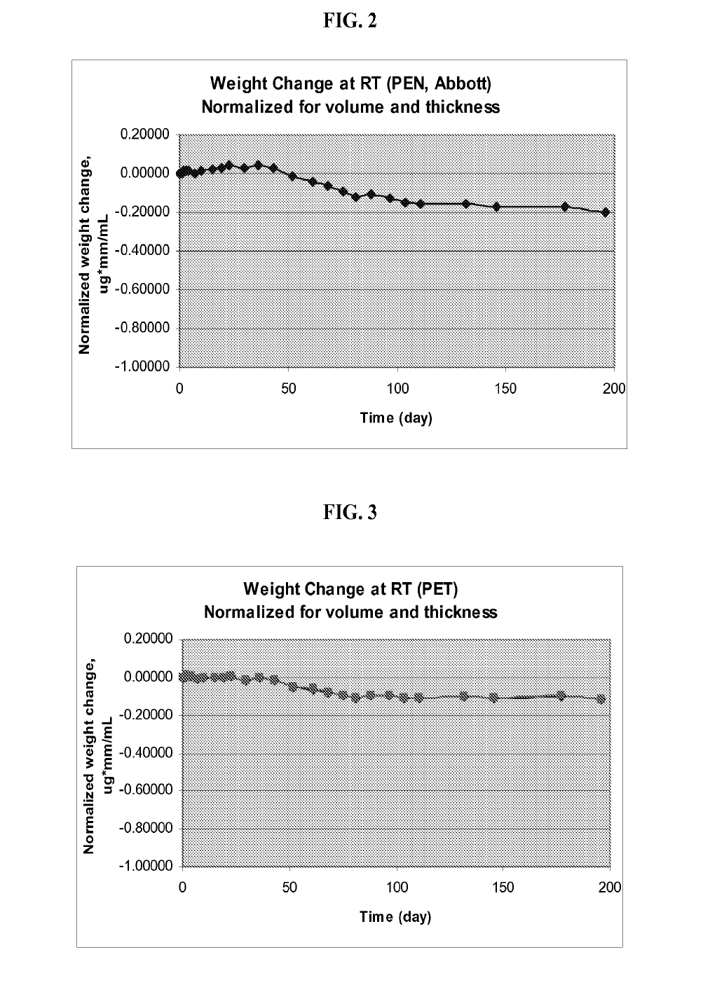

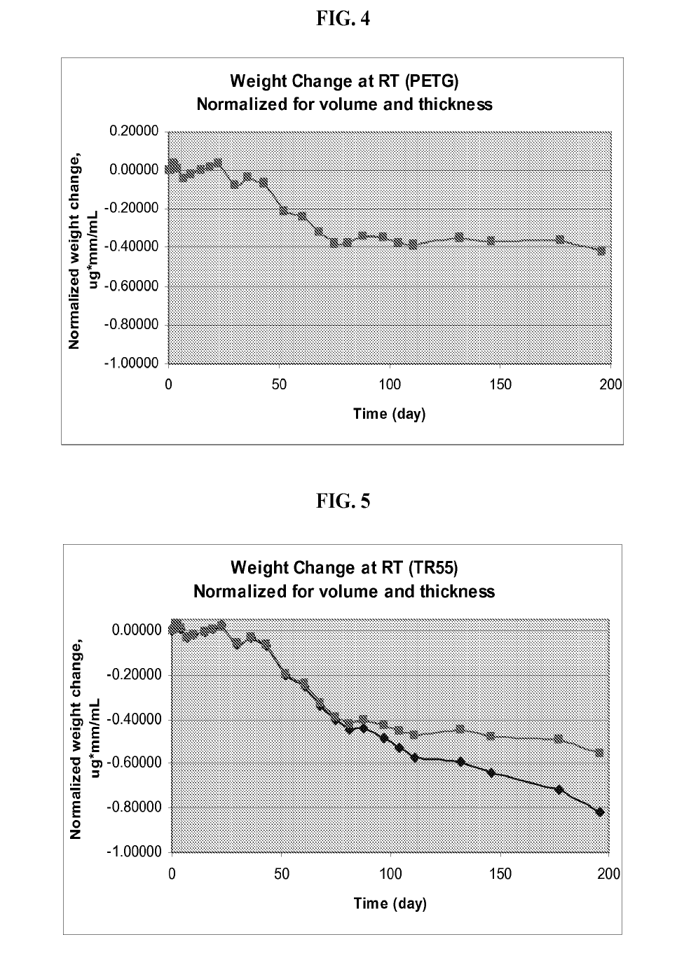

The permeation of sevoflurane in plastic bottles was evaluated by monitoring the weight loss of sevoflurane in the bottles over time. Sevoflurane was packaged in four different bottles either made from PET, PETG, amorphous nylon (GRILAMID® TR55), or PEN. FIGS. 2 through 5 are plots of normalized weight loss of sevoflurane in the different types of bottles over time. The amount of sevoflurane placed in each bottle was approximately 5% of the total volume of the bottle. The normalized weight change was calculated with the formula:

weight loss=[(total weight)₀−(total weight)ₜ]*thickness/volume

where (total weight)₀ is the weight of the sealed bottle with sevoflurane at day 0, (total weight)ₜ is the weight of the sealed bottle with sevoflurane at day t, the thickness is the average thickness of the side wall of the bottle, and the volume is the total volume of the bottle.

FIGS. 2 through 5 show the weight loss of sevoflurane over time for each bottle. In FIGS. 2 through 5, one can see that the containers PET, PETG, and amorphous nylon GRILAMID® TR55 exhibited a similar pattern of weight change. That is, there is an initial “stable” period, followed by a weight decrease from about 50 to 100 days, and then another stabilization period. Table 1 shows the normalized data reflecting the percent weight change of sevoflurane over time in the various containers.

TABLE 1

| | | | | | Actual % |
|---|---|---|---|---|---|
| | % Normalized Weight Change of Sevoflurane | | | | Weight Loss |
| Polymer | Day 3 | Day 52 | Day 104 | Day 196 | Day 196 |
| PEN | 0.0015 | −0.0014 | −0.149 | −0.200 | −0.195 |
| PET | 0.008 | −0.050 | −0.110 | −0.113 | −0.257 |
| Nylon | 0.023 | −0.197 | −0.49 | −0.55 | −0.745 |
| (TR55) | | | | | |
| PETG | −0.02039 | −0.211 | −0.376 | −0.418 | −0.592 |

### Example 2

### Degradation of Sevoflurane in Thermoplastic Containers

Sevoflurane samples were stored in various containers for 196 days and were analyzed per USP monograph methods for chromatographic purity, fluoride content, and water content. The results are listed in Table 2. The chromatography results indicate that sevoflurane did not show more degradation or generate additional unknown impurity. The amount of total impurity in each sample, ranging from 12 to 19.5 μg/g, was much lower than the USP specification of 300 μg/g. The fluoride content in the samples was also much lower than the USP specification of 2 μg/mL. Water content in all tested samples met the USP specification of 0.1%. The results demonstrate that the containers tested are chemically compatible with sevoflurane. Related compounds A, B, and C used in the experiment are USP impurity standards. These structures can be found in the USP sevoflurane monograph. USP Sevoflurane Related Compound A RS [1,1,1,3,3-pentafluoroisopropenyl fluoromethyl ether] (C₄H₂F₆O M.W. 179.97); USP Sevoflurane Related Compound B RS [1,1,1,3,3,3-hexafluoro-2-methoxy-propane]; and USP Sevoflurane Related Compound C RS [1,1,1,3,3,3-hexafluoro-2-propanol].

TABLE 2

| | Sevoflurane | Related | Related | Related | Total | Fluoride | Water |
|---|---|---|---|---|---|---|---|
| | potency | Compound A | Compound B | Compound C | Impurity | content | Content |
| Item | (%) | (ug/g) | (ug/g) | (ug/g) | (ug/g) | (ug/mL) | (%) |
| USP | 99.97 | NMT 25 ug/g | NMT 100 ug/g | NMT 100 ug/g | NMT 300 ug/g | NMT 2 ug/mL | NMT 0.1% |
| specification | | | | | | | |
| TR45 | 100.00 | 4.8 | 7.3 | 0 | 12.0 | not enough sample | not tested |
| TR45 | 100.00 | 6.8 | 9.9 | 0 | 16.7 | 0.050 | not tested |
| TR55 | 100.00 | 7.2 | 10.8 | 0 | 18.0 | 0.033 | 0.0481 |
| TR55 | 100.00 | 7.0 | 10.5 | 0 | 17.6 | 0.023 | 0.0478 |
| TR90 | 100.00 | 6.2 | 10.6 | 0 | 16.8 | 0.023 | 0.0482 |
| TR90 | 100.00 | 3.9 | 7.8 | 0 | 11.7 | 0.052 | 0.0481 |
| PET | 100.00 | 7.0 | 10.4 | 0 | 17.4 | 0.022 | 0.058 |
| PET | 100.00 | 7.1 | 10.4 | 0 | 17.5 | 0.020 | 0.0593 |
| FEP | 100.00 | 6.7 | 10.9 | 0 | 17.6 | 0.149 | not tested |
| PETg | 100.00 | 7.0 | 10.2 | 0 | 17.2 | 0.037 | not tested |
| PETg | 100.00 | 7.2 | 10.7 | 0 | 17.9 | 0.042 | not tested |
| PEN | 100.00 | 8.0 | 11.5 | 0 | 19.5 | 0.017 | 0.0439 |

### Example 3

### Detection of Non-Volatile Residue from Sevoflurane Containers

Another aspect of the chemical/physical compatibility of the bottle with sevoflurane is that there should be no extractables and leachables coming out of the plastic over time with sevoflurane storage. Nonvolatile residue was determined in several packages according to USP test procedure (USP 31-NF for Sevoflurane) with a slight modification, i.e., the sample volume was scaled down and the drying of sevoflurane was done in an oven rather than over a steam bath. The results are shown in Table 3. All the tested bottles met the USP specification (weight of the residual does not exceed 1.0 mg per 10.0 mL) for nonvolatile residue.

TABLE 3
Nonvolatile residue for sevoflurane stored in various bottles.

| | | | | | | Weight | |
|---|---|---|---|---|---|---|---|
| | | | Initial | Volume | Final | Difference | Adjusted |
| | Vial | | Weight | Added | Weight | (Residual) | for |
| Sample ID | No. | resin | (g) | (mL) | (g) | (mg) | 10.0 mL |
| SA-043-003-01-007 | 3 | TR55 | 13.23076 | 8.0 | 13.23066 | −0.1 | −0.12 |
| SA-043-003-01-008 | 4 | TR55 | 13.23307 | 8.0 | 13.23308 | 0.01 | 0.01 |
| SA-043-003-01-009 | 5 | TR90 | 13.11717 | 7.0 | 13.11720 | 0.03 | 0.04 |
| SA-043-003-01-010 | 6 | TR90 | 13.19930 | 2.0 | 13.19927 | −0.03 | −0.15 |
| SA-043-003-01-011 | 7 | PET | 13.19724 | 7.0 | 13.19731 | 0.07 | 0.10 |
| SA-043-003-01-012 | 8 | PET | 13.34239 | 7.0 | 13.34259 | 0.2 | 0.29 |
| SA-043-003-01-016 | 15 | PEN | 13.19235 | 10.0 | 13.19241 | 0.06 | 0.06 |

### Example 4

### Environmental Stress Crack Screening for Sevoflurane Containers

Sevoflurane containers were screened for environmental stress cracking resistance (ESCR) to the liquid or gas sevoflurane. In one simple method, containers are squeezed with sevoflurane present and observed for the presence of a crack or split. PET bottles after 196 days showed no effects.

In another method, a standard ring bending test was performed with the container materials soaked in sevoflurane for more than 24 hrs, similar to that detailed in ISO 22088-3:2006. The strips can be evaluated physically by the appearance of stress-cracking, or reduced strength in a tensile stress-strain machine. PET resistance to several solvents is reported by Moskala and Jones, Evaluating Environmental Stress Cracking of Medical Plastics, Medical Plastics and Biomaterials, May 1998. Values for stress cracking for PET range from 0.3% for aggressive solvents to over 2% for water.

Stainless steel tubes of outer diameters of 1″, 1.5″, and 2″ were cut into 1 cm lengths. The 1.5″ and 2″ rings were split. Strips of PET were cut from the length of the sidewall of a container about 1 cm in width. The strips were then bent and inserted into the 1″ diameter ring to give a radius equivalent to the radius between the ends of the strips inside the ring, i.e., 10 mm. For the larger radii rings, the PET strips were clamped on the outer surface by paper clips. The assemblies were then placed in a wide-mouth bottle, immersed with sevoflurane at room temperature, and observed over several days.

The outer fiber strain is related to the radius of curvature, which is the thickness of the strip divided by the diameter of the circle. An estimation of the outer fiber stress can be gained by multiplying the strain by the modulus. For PET bottles the modulus is given as about 2 GPa. For the specimens in this experiment, the initial outer fiber strains were calculated as 3, 1.6, and 1.2% with increasing sample radius.

Microcracking or crazes (voided microcracks) were observed at all strains, but at the lowest strain gave very fine crazes that could be observed when holding the sample against light at an appropriate angle. In no case did the specimens crack after several days.

Although various specific embodiments of the present invention have been described herein, it is to be understood that the invention is not limited to those precise embodiments and that various changes or modifications can be affected therein by one skilled in the art without departing from the scope and spirit of the invention.

What is claimed is:

1. An inhalation anesthetic product comprising:
a container constructed from a material comprising a compound selected from the group consisting of a polyester containing a terephthalate ester group, an amorphous nylon, fluorinated ethylene-propylene, and combinations thereof, the container defining an interior space constructed to contain therein, external to a patient's body, an inhalation anesthetic comprising a fluoroether agent; and
a volume of the inhalation anesthetic contained in the interior space defined by the container.

2. The inhalation anesthetic product of claim 1, wherein the material comprises a compound selected from the group consisting of polyethylene terephthalate and polyethylene terephthalate glycol co-polyester.

3. The inhalation anesthetic product of claim 1, where the fluoroether agent is selected from the group consisting of sevoflurane, desflurane, isoflurane, enflurane, and methoxyflurane.

4. The inhalation anesthetic product of claim 1, wherein the container further comprises a material comprising polyvinyl acetate or polyvinyl alcohol.

5. The inhalation anesthetic product of claim 1, wherein the permeation of the inhalation anesthetic through the material is less than about 2% by weight per one year at room temperature storage.

6. The inhalation anesthetic product of claim 1, wherein the material has a thickness of more than about 100 μm.

7. The inhalation anesthetic product of claim 1, wherein the container defines an opening therein, the opening providing fluid communication between the interior space defined by the container and an external environment of the container, the inhalation anesthetic product further comprising a cap, the cap constructed to seal the opening, the cap constructed from a material comprising a compound selected from a group consisting of polyethylene, polyethylene napthalate, polymethylpentene, ionomeric resins, polyesters containing a terephthalate ester group, an amorphous nylon, fluorinated ethylene-propylene, and combinations thereof.

8. The inhalation anesthetic product of claim 1, wherein the container defines an opening therein, the opening providing fluid communication between the interior space defined by the container and an external environment of the container, the inhalation anesthetic product further comprising a cap having an interior surface, the cap constructed to seal the opening, the interior surface of the cap constructed from a material comprising a compound selected from a group consisting of a polyester containing a terephthalate ester group, an amorphous nylon, fluorinated ethylene-propylene, polyvinyl alcohol, and combinations thereof.

9. A method for storing an inhalation anesthetic external to a patient's body, the method comprising the steps of:
providing a container defining an interior space, wherein the container is constructed from a material comprising a compound selected from the group consisting of a polyester containing a terephthalate ester group, an amorphous nylon, fluorinated ethylene-propylene, and combinations thereof; and
placing a volume of a fluoroether agent in the interior space defined by the container.

10. The method of claim 9, wherein the polyester containing a terephthalate ester group is selected from the group consisting of polyethylene terephthalate and polyethylene terephthalate glycol co-polyester.

11. The method of claim 9, where the fluoroether agent is selected from the group consisting of sevoflurane, desflurane, isoflurane, enflurane, and methoxyflurane.

12. The method of claim 9, wherein the container further comprises a material comprising polyvinyl acetate or polyvinyl alcohol.

13. The method of claim 9, wherein the container defines an opening therein, the opening providing fluid communication between the interior space defined by the container and an external environment of the container, the inhalation anesthetic product further comprising a cap, the cap constructed to seal the opening defined in the container, the cap constructed from a material comprising a compound selected from a group consisting of polyethylene, polyethylene napthalate, polymethylpentene, ionomeric resins, polyesters containing a terephthalate ester group, an amorphous nylon, fluorinated ethylene-propylene, and combinations thereof.

14. The method of claim 9, wherein the container defines an opening therein, the opening providing fluid communication between the interior space defined by the container and an external environment of the container, the inhalation anesthetic product further comprising a cap having an interior surface, the cap constructed to seal the opening defined in the container, the interior surface of the cap constructed from a material comprising a compound selected from a group consisting of polyesters containing a terephthalate ester group, an amorphous nylon, fluorinated ethylene-propylene, and combinations thereof.
